(19) United States
(12) Patent Application Publication
(10) Pub. No.: US 2004/0070990 A1
(43) Pub. Date: Apr. 15, 2004

(54) LED illuminator and method of manufacture

(76) Inventor: Witold Szypszak, Quincy, MA (US)

Correspondence Address: Alan R. Thiele, JENKENS & GILCHRIST, P.C., Suite 3200, 1445 Ross Avenue, Dallas, TX, 75202-2799, US

(21) Appl. No.: 10/262,037

(22) Filed: Oct. 1, 2002

(51) Int. Cl. F21V 7/04

(52) U.S. Cl. 362/555

(57) ABSTRACT

An self-contained illuminator capable of being manufactured in a plurality of shapes is built around a circuit board. The circuit board enables attuning the position of the light emitting diode assemblies to maximize light output and also provides for mounting the electrical componentry needed to control and supply the required amount of electrical energy to the LED assemblies. The circuit board also provides a substrate for a layer of the self-hardening flowable medium used to hold the light emitting diodes in their attuned position.

### FIELD

The present invention pertains to LED illuminators; more particularly, the present invention pertains to illuminators using LED assemblies as a light source for general inspection, machine vision, microscopy, photography, and other similar applications.

### BACKGROUND

The market for machine vision and microscopy illumination is currently dominated by fiber optic illuminators. While effective, fiber optic illuminators are considered by most users to be both bulky and expensive. In addition, the separately housed light source in a fiber optic illuminator emits a lot of heat and the light source, together with the bulky light guide, can occupy a lot of precious space in a user's workspace.

Because of recent advances in the amount of light emitted by light emitting diodes, it has been found that groups of LEDs can provide a better source of light than fiber optic illuminators for general inspection, machine vision, microscopy, photography, and other similar applications.

One of the problems with the use of groups of LED assemblies as a light source is that no two individual LED assemblies have exactly the same optical properties. The shape and directivity of the light beam generated by individual LED assemblies are different, sometimes substantially different. This difference in optical properties is based, in part, on the positioning of the chip inside the cup and the positioning of the cup with respect to the lens. Due to the nature of the manufacturing process of individual LED assemblies, there are no tight positional tolerances associated with the locations of the components in an individual LED assembly. Pointing a group of individual LED assemblies in the general direction of a target results in unpredictable, but always uneven, distribution of the light on the target. Beams from two or more individual LED assemblies may substantially concentrate on a portion of the target to form a bright spot, while, at the same time, making other areas of the target darker. Only a very effective diffuser will diffuse unevenly distributed light emitted by LED assemblies to minimize the illumination of bright spots and increase the illumination of dark spots. Such diffusers introduce a substantial loss of light intensity, which loss of light intensity makes an illuminator energy inefficient. Therefore, for any application which requires efficient and even illumination of a specific area, more than a simple grouping of individual LED assemblies behind a diffuser is required.

Light emitted from an individual LED assembly is not evenly distributed. The shape of the light-emitting chip is always projected on the target as a high intensity area. Reflections from the electrodes and walls form unpredictable patterns of light superimposed on the main beam of light. As a result, undesirable hot spots and shadows appear on the object being illuminated. Accordingly, for any lighting application requiring a substantially even or uniform distribution of light over a predetermined area, a transmitting or partial diffuser must be used to scatter the light emitted from each individual LED assembly so that the hot spots and shadows do not appear on the object being illuminated. But, while a diffuser will eliminate hot spots and shadows, it is important that the “directivity” or geometry of the light beam emitted from an individual LED assembly not be degraded or diminished.

U.S. Pat. No. 4,972,093 describes a lighting system using individual LED assemblies directed toward a light field and arranged to form a lighting array. The light impinges on the target substantially un-diffused. Because the individual LED assemblies are not positioned for maximizing their effectiveness, only specific portions of the target are illuminated.

U.S. Pat. No. 5,822,053 addresses both issues—the need for individual alignment or attunement of the individual LED assemblies, as well as the need for proper diffusion of the light emitted from each individual LED assembly. The methods described in U.S. Pat. No. 5,822,053 include using a base plate with predrilled holes. The diameter of each predrilled hole in the base plate is made larger than the body of the LED assembly to be placed within the predrilled hole so that the LED assembly can move freely in all directions. Each individual LED assembly is inserted through the predrilled hole in the base plate, energized, and pointed toward a specific area of the target. While the individual LED assembly is being held in place with respect to the predrilled hole in the base plate, a few drops of a UV-curable adhesive are applied to secure the body of the individual LED assembly to the base plate. The adhesive around each individual LED assembly is cured using a UV gun. This curing process creates a permanent bond between the base plate and the body of each individual LED assembly. The LED assembly must be held steady, with its light beam illuminating the specific area of the target, until the UV-curable adhesive sets to provide sufficient mechanical support for the LED assembly. The UV-curable adhesive is separately cured for each LED assembly. The use of a base plate and the disclosed method for alignment or attunement of each LED assembly is time-consuming and awkward. As in other prior art illuminators, the use of a stand-alone controller is well known. This stand-alone controller is positioned away from the individual LED assemblies and houses all electronic components and circuits needed to provide the required electrical energy for each LED assembly. In many applications, especially where available space is limited, the use of a stand-alone controller is very inconvenient.

Accordingly, there remains in the art a need for a low cost, easy to manufacture, LED illuminator in which the LED assemblies are individually attuned, a light diffuser may be used without detracting significantly from the energy efficiency of the illuminator, and the need for a stand-alone controller is eliminated.

### SUMMARY

The present invention provides a low cost, easy to manufacture LED illuminator and a method for its manufacture. The individual LED assemblies are electrically connected to a printed circuit board in a predetermined pattern and attuned to form the intended pattern of illumination. The electronic circuitry needed to supply the required amount of electrical energy to each individual LED assembly is also electrically connected to the printed circuit board and becomes an integral part of the LED illuminator.

The construction of the disclosed LED illuminator uses a printed circuit board as a foundation. All of the individual LED assemblies and the electronic componentry needed to control the individual LED assemblies, including the necessary power connections as well as the potentiometers needed to regulate the light intensity of each individual LED assembly are soldered to the printed circuit board. Specifically, a group of individual LED assemblies is soldered to extend a predetermined distance from one side of the printed circuit board. All other components for regulating the flow of electrical energy provided to the LED assemblies are also soldered to the printed circuit board. Once the soldering of the individual LED assemblies and the electronic componentry to the printed circuit board is complete, the LED illuminator is still only partially complete. The LED assemblies and the electronic componentry may now be tested and burnt-in for as long as needed to guarantee almost indefinite operation. It is at this point during the manufacturing process that the light output associated with each individual LED assembly is evaluated.

To evaluate the optical characteristics of the light output of the individual LED assemblies and to perform the necessary attunement, the partially completed LED illuminator is placed in an alignment fixture so the light emitted by each individual LED assembly is directed toward the object to be illuminated, which fixture is placed at a predetermined position and distance with respect to the target. Each individual LED assembly (one by one) is then supplied with the necessary electrical energy to produce a desired level of emitted light. The electrical leads of the currently energized LED assembly are then bent above the printed circuit board a few millimeters below the body of the individual LED assembly using an adjustment tool. By bending the electrical leads, the light beam from each individual LED assembly is specifically pointed toward the desired area of the target. The electrical leads of the LED assembly are flexible enough to be bent easily, but firm enough to provide reliable mechanical support for each LED assembly during the remainder of the attunement process. Once the alignment or attunement process is complete, the partially completed LED illuminator is removed from the alignment fixture and the side of the printed circuit board from which the LED assemblies extend is covered with one or more layers of epoxy to hold each individual LED assembly in the desired attuned position.

A complete LED illuminator according to the present invention includes a printed circuit board, a collection of individual aligned LED assemblies soldered to extend from one side of the printed circuit board, the electronic componentry needed to control the flow of electrical energy to the set of aligned individual LED assemblies, and an epoxy layer to affix the position of the aligned or attuned individual LED assemblies.

The electronic componentry electrically connected to the printed circuit board may include a suitable power connector and one or more potentiometers for adjusting the light intensity. If needed, metal or plastic standoffs, as well as other mounting hardware, may also be secured to the printed circuit board. It is the rigidity of the one or more layers of epoxy, combined with the rigidity of a laminated fiberglass printed circuit board, that provides both structural integrity to the illuminator module as well as mechanical support for the set of individual aligned or attuned LED assemblies and for whatever mounting hardware may be fully or partially embedded in the one or more layers of epoxy.

According to the disclosed LED illuminator and method of manufacture, the following advantages are provided:

1. The need for an external stand-alone controller is eliminated, as all of the electronic componentry needed to control the intensity of light from each individual LED assembly is an integral part of the LED illuminator;

2. All components, including the set of individual aligned or attuned LED assemblies, are simply soldered to the printed circuit board, making the disclosed LED illuminator easy to manufacture and test;

3. The attachment of the individual LED assemblies to the printed circuit board by soldering simplifies the process of attunement of the individual LED assemblies;

4. A layer of epoxy provides permanent mechanical support for the set of individual aligned LED assemblies and heat dissipation for the heat generated by the set of individual aligned LED assemblies and electrical leads;

5. When used, an outer layer of clear epoxy covering the LED assemblies may serve as a diffuser for the light emitted from the individual LED assemblies and/or be shaped for other optical action;

6. When either a single thick layer or multiple layers of epoxy are deposited on the printed circuit board, there is no need for any heavy or elaborate housing to contain the LED illuminator; and

7. All parts of the illuminator may be contained in epoxy to form a rigid one-piece illuminator that is suitable for use in harsh environments.

Accordingly, the LED illuminator of the present invention may be used for photography, video, general inspection, machine vision, microscopy, reading aids, shop windows, and other expositions, or any application where even, directional, or surrounding illumination of an object is required.

### BRIEF DESCRIPTION OF THE DRAWING FIGURES

A better understanding of the LED illuminator of the present invention may be had by reference to the drawing figures, wherein:

FIG. 1a is a cross-sectional view at VI-VII of FIG. 1b of a spot or circle LED illuminator according to the present invention;

FIG. 1b is a plan view of the LED illuminator shown in FIG. 1a;

FIG. 2a is a cross-sectional view at VI-VII of FIG. 2b of an LED illuminator similar to that shown in FIG. 1a;

FIG. 2b is a plan view of the LED illuminator shown in FIG. 2a;

FIG. 3a is an cross-sectional view at VI-VII of FIG. 3b of a ring LED illuminator with a clear epoxy layer molded over the array of LEDs;

FIG. 3b is a plan view of a LED illuminator shown in FIG. 3a;

FIG. 4a is a cross sectional view at VI-VII of FIG. 4b of a rectangular LED illuminator including a central magnifier;

FIG. 4b is a plan view of the LED illuminator shown in FIG. 4a;

FIG. 5a is a side sectional view at VI-VII of FIG. 5b of the front plate of a spot or circle LED illuminator including lensatic rings;

FIG. 5b is a plan view of the front plate shown in FIG. 5a;

FIG. 6a is a cross-sectional view at VI-VII of FIG. 6b of a spot or circle LED illuminator with a dome light diffuser;

FIG. 6b is a plan view of the LED illuminator shown in FIG. 6a;

FIG. 7a is a cross sectional view at VI-VII of FIG. 7b of a stick LED illuminator;

FIG. 7b is a plan view of the LED illuminator shown in FIG. 7a;

FIG. 7c is a cross-sectional view at VIII-IX of FIG. 7b;

FIG. 7d is an alternate cross-sectional view at VIII-IX of FIG. 7b;

FIG. 8a is a cross-sectional view of an exploded ring LED illuminator including threaded connections for lenses or light filters;

FIG. 8b is a cross-sectional view of an exploded spot or circle illuminator including threaded connections for lenses or light filters;

FIG. 9 is a perspective view of a workbench light including a rectangular LED illuminator;

FIG. 10a is a schematic view of an LED assembly;

FIG. 10b is a schematic view of a surface mount LED assembly;

FIG. 11 is a cross-sectional view and a magnified plan view of an LED assembly, mounted on a printed circuit board in a substantially circular through-hole, and secured thereto with a layer of epoxy;

FIG. 12 is a cross-sectional view including a magnified plan view, similar to

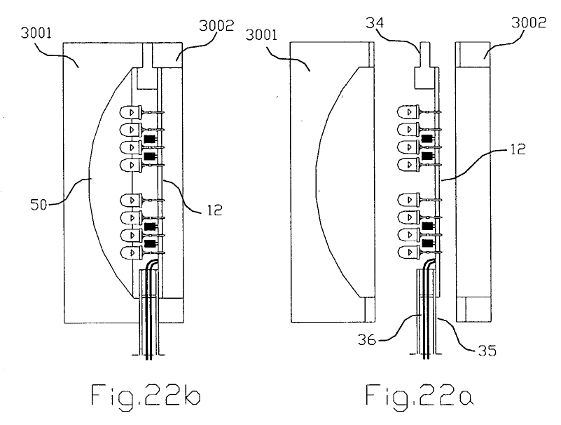

FIG. 11, showing an elongated through-hole;

FIG. 13 is a schematic view similar to FIG. 12 showing the LED assembly in close proximity to the printed circuit board;

FIG. 14a is a schematic view similar to FIG. 13 showing the LED assembly secured thereto with a bead of epoxy;

FIG. 14b is a schematic view showing the attunement of a surface mount LED;

FIG. 14c is a schematic view showing the attunement of an LED chip;

FIG. 15a is a circuit diagram illustrating a portion of the electronic componentry for a computer-controlled illuminator;

FIG. 15b is a diagram illustrating a portion of the electronic componentry for a manually controlled illuminator;

FIG. 16 is a schematic view of the emitted pattern of light from an LED;

FIG. 17a is a perspective view of a lens section that may be used on an LED illuminator;

FIG. 17b is a cross-sectional view of a plano converging lens shape;

FIG. 17c is a cross-sectional view of a plano diverging lens shape;

FIGS. 18a, 18b and 18c are cross-sectional views of a spot or circle LED illuminator with a single layer of epoxy in various stages of the molding process;

FIGS. 19a, 19b, and 19c are cross-sectional views of a spot or circle LED illuminator with two layers of epoxy in various stages of the molding process;

FIG. 20a is a cross-section view of an insert used to form the inner walls of an LED illuminator;

FIGS. 20b, 20c, and 20d are cross-sectional views of a spot or circle LED illuminator with two layers of epoxy and molded inner walls in various stages of the molding process; and

FIGS. 21a, 21b and 21c are cross-sectional views of a spot or circle LED illuminator with three layers of epoxy in various stages of the molding process.

### DESCRIPTION OF THE EMBODIMENTS

General

As shown in FIGS. 1a and 1b, a spot or circle LED illuminator 10 according to the present invention is built around a single substantially circular laminated fiberglass printed circuit board 12. All individual LED assemblies and the electronic componentry needed to control the emitted light of each individual LED assembly 20, including the appropriate power connections and one or more potentiometers for adjusting the light intensity emitted from each individual LED assembly 20, are soldered to or mounted on the single printed circuit board 12. The set of individual LED assemblies 20 extends from one side of the printed circuit board 12 and the electronic componentry may extend from one or both sides of the printed circuit board 12.

In the preferred embodiment, a 12V-24V DC wall-transformer is used to supply electrical energy to the illuminator 10, although any other source of DC voltage in the specified range may be used. The intensity of the emitted light from either individual LED assemblies or a subset of LED assemblies 20 is adjusted by one or more potentiometers 34. Knobs used to control the potentiometers 34 are positioned to be easily accessible to the user.

All LED assemblies 20 are soldered to the printed circuit board. Then each LED assembly is individually aligned or attuned, by bending its leads, so that its light beam is illuminating a specific and predetermined area of the target. A layer of epoxy 40, chosen for its mechanical and thermal specifications, is applied on the side of the printed circuit board 12 from which the light emitting portion of each LED assembly 20 extends. Each individual LED assembly 20, after being individually attuned, is partially submerged in the layer of epoxy 40. The layer of epoxy 40 both provides mechanical support for the individual aligned LED assemblies 20 and provides a heat transfer medium extending from the body of each of the individual LED assemblies 20 and electrical leads 24. The combination of the hardened layer of epoxy 40 with the inherent strength of the laminated fiberglass printed circuit board 12 provides enhanced structural integrity to the LED illuminator 10. Mounting bracket 17 is attached with screw 13 to standoff 14 embedded in the epoxy layer 40. Back cover 18 and diffusing front cover 16 are also attached with screws 13 to standoffs 14 embedded in the epoxy layer 40.

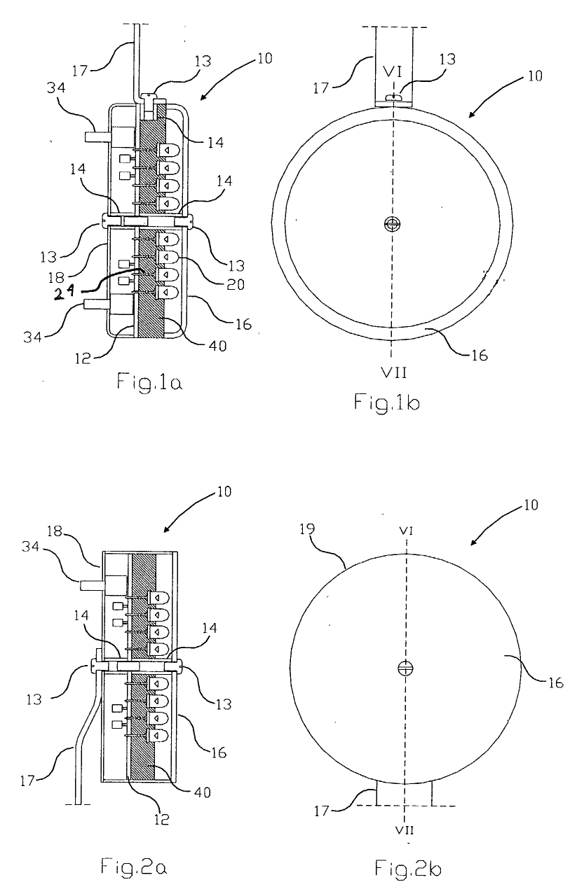

As shown in FIGS. 2a and 2b, tubing section 19 may be placed around the contours of the LED illuminator 10 to serve as a sidewall. Tubing section 19 is sandwiched between the diffusing front cover 16 and the back cover 18 and needs no mechanical support. A mounting bracket 17 is attached with a screw 13 to the standoff 14 that also holds the back cover 18.

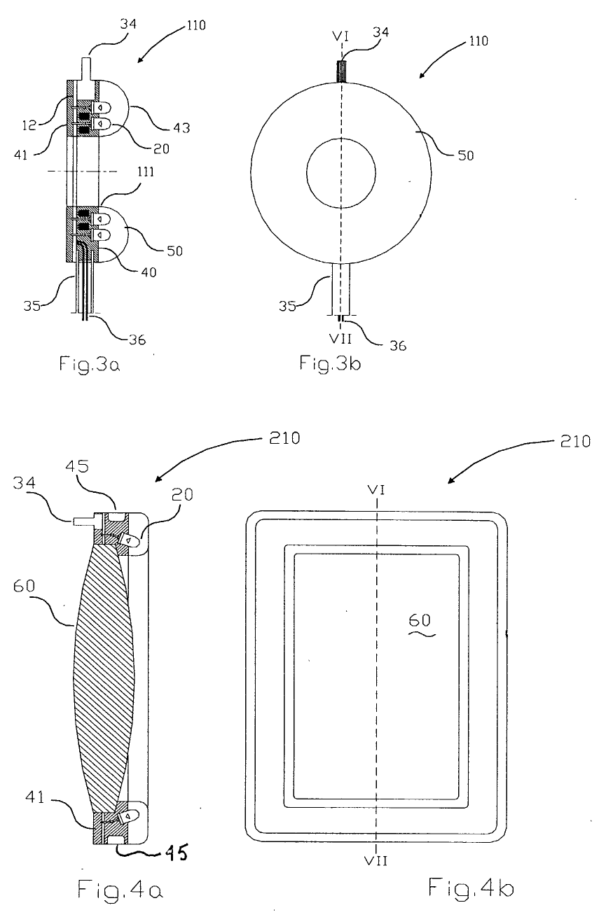

As shown in the ring LED illuminator 110 shown in FIGS. 3a and 3b, instead of attachable diffusing front cover, a second layer of clear epoxy 50 may be molded on top of the first layer of epoxy 40 with a central hole formed therein. In this embodiment all electronic components, including a potentiometer 34 are placed on the same side of the printed circuit board as the LED assemblies. The back side of the printed circuit board is also covered with a layer of epoxy 41. A tip of a flexible or non-flexible arm 35 is embedded in epoxy layer 40 and serves as mounting hardware for the illuminator 110, and as a conduit for two wires 36 supplying DC voltage. The wires 36 are soldered directly to the printed circuit board. The layer of clear epoxy 50 may be shaped either flat or curved to form a lens. The outer surface 52 of the clear epoxy 50 may have a roughened surface or may be molded into a “wavy” pattern to act as a light diffuser.

In yet another embodiment, additives well known to those of ordinary skill in the art in the form of small particles or dyes, may be mixed with the clear epoxy before the molding process to add special effects to the emitted light such as diffusion, color, fluorescence, or filtering.

In yet another alternate embodiment, the electronic componentry of each LED illuminator 20 may include a strobe or gate input. If a strobe or gate input is used, an external generator or switch with an “open-collector” output may be connected to this strobe or gate input to effect strobing or gating on the emitted light from one or more of the individual LED assemblies. Any time the strobe or gate input is open or floating, the LED illuminator generates light. When the strobe or gate input is forced to ground or low level by an external device, the entire LED illuminator or a portion thereof ceases to generate light.

Because of the rigidity and strength of a hardened layer of epoxy and the rigidity of a laminated fiberglass printed circuit board 12, the, LED illuminator 10 of the present invention is able to be a self-contained unit which provides mechanical support for all needed electronic componentry.

It has been found that even in large LED illuminators there is no need for a housing to contain the LED illuminator. Instead, the LED illuminator actually may provide structural support for other devices such as a large magnifying glass 60. Shown in FIGS. 4a and 4b is an LED illuminator 210 made in the shape of a rectangular frame to surround a large rectangular magnifying glass 60. Indentations 45 may be molded into the epoxy layer 40 to provide for a swivel or pivotable mounting.

Those of ordinary skill in the art will understand that LED illuminators according to the present invention may be produced in virtually any shape at a very low cost. For example, it is possible to produce shapes with arcuate or straight sides, full 360° ring-lights, smaller cuts of 360° ring-lights, blocks, sticks, or frames.

As previously described, shown in FIGS. 3a and 3b is a ring shaped LED illuminator 110 where the inner and outer walls of the epoxy layer 50 are formed to be an arcuate lens. Alternatively, the epoxy layer 50 may be formed with flat walls. The inner wall 111 of the LED illuminator 110 is constructed to surround and illuminate an object located within the ring. If variation of the intensity of the emitted light is a needed feature, the intensity of the light emitted from the set of individual aligned LED assemblies or subsets of individual aligned LED assemblies may be adjusted by turning the potentiometer knobs 34 which are positioned at any convenient portion of the LED illuminator.

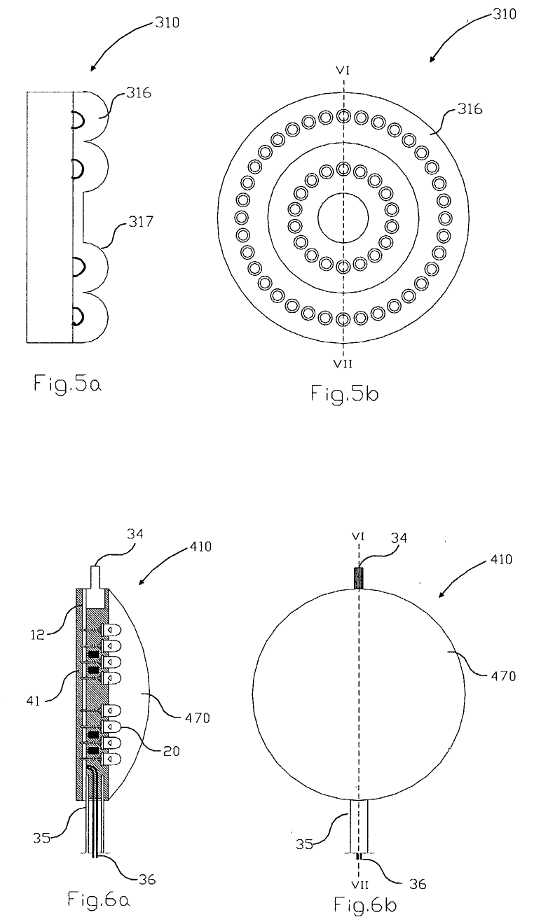

As shown in FIGS. 5a and 5b, the front portion 316 of an LED illuminator 310 may be formed to include lensatic rings 317. Alternatively, the lensatic rings 317 may be molded into an outer epoxy layer. Or, as shown in FIGS. 6a and 6b, the light rays from the individual LED assemblies 20 may pass through a dome diffuser 470 molded at the front of the LED illuminator 410.

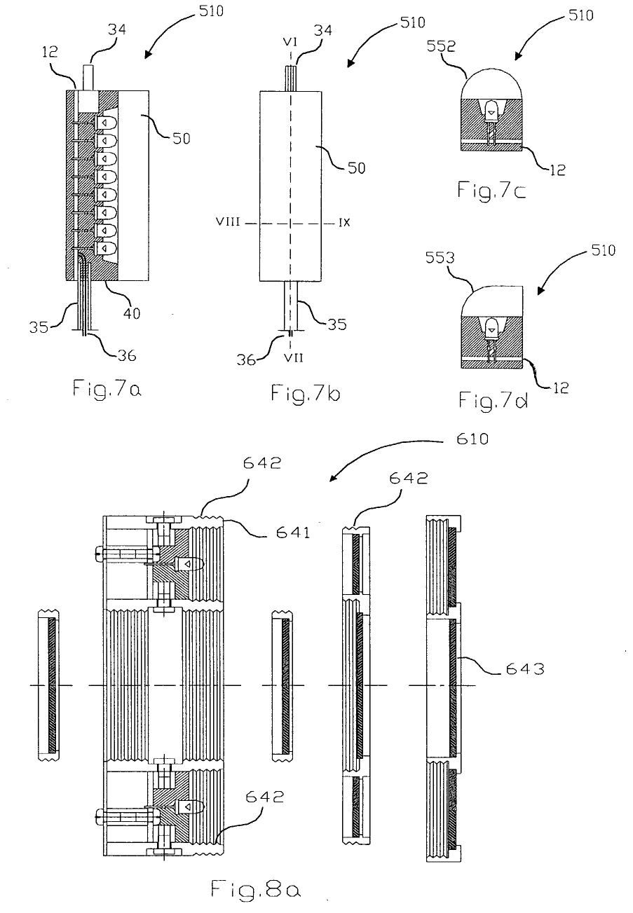

As shown in FIGS. 7a and 7b, the LED illuminator 510 may be formed as a stick with a semicircular lens 552, as shown in FIG. 7c, or a half-lens 553, as shown in FIG. 7d, either attached or formed on one edge.

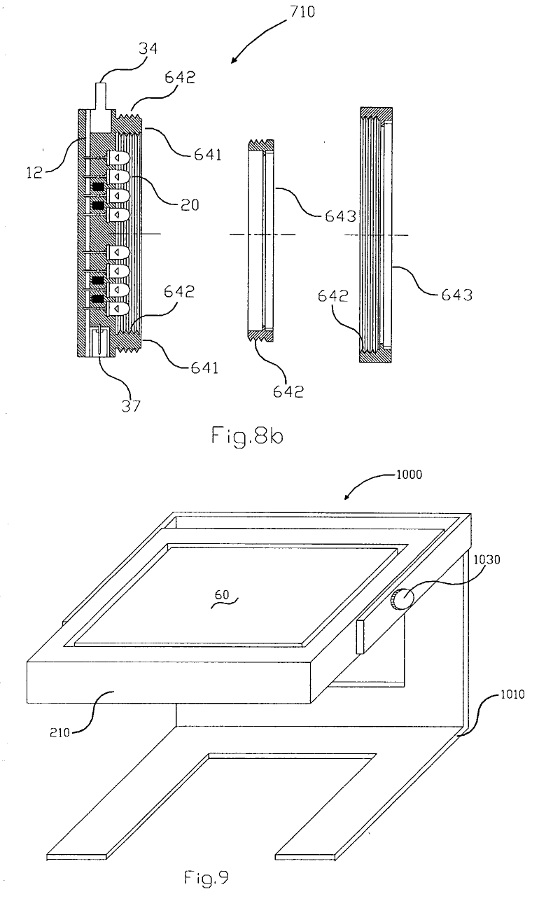

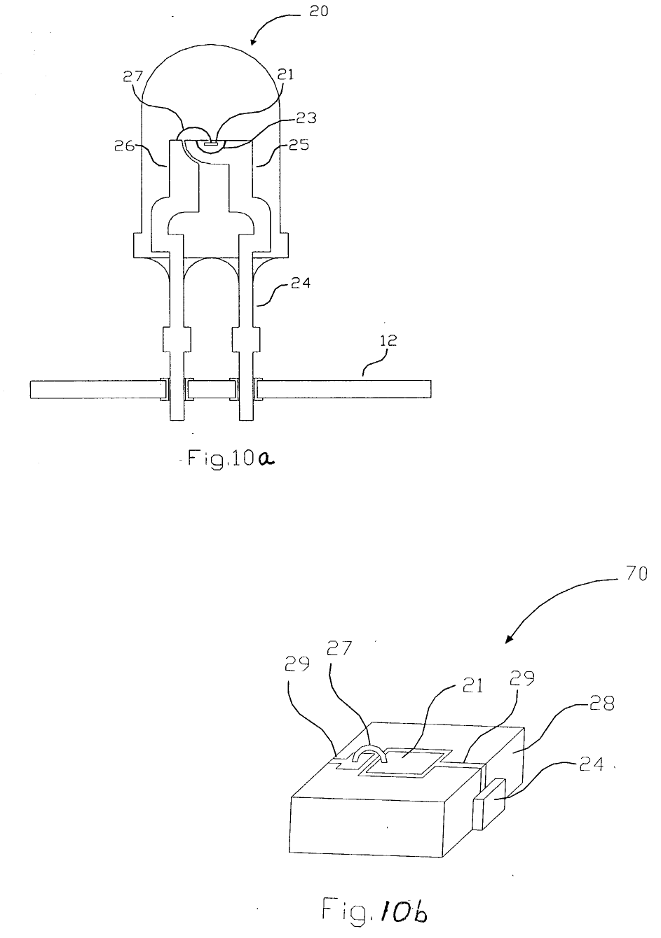

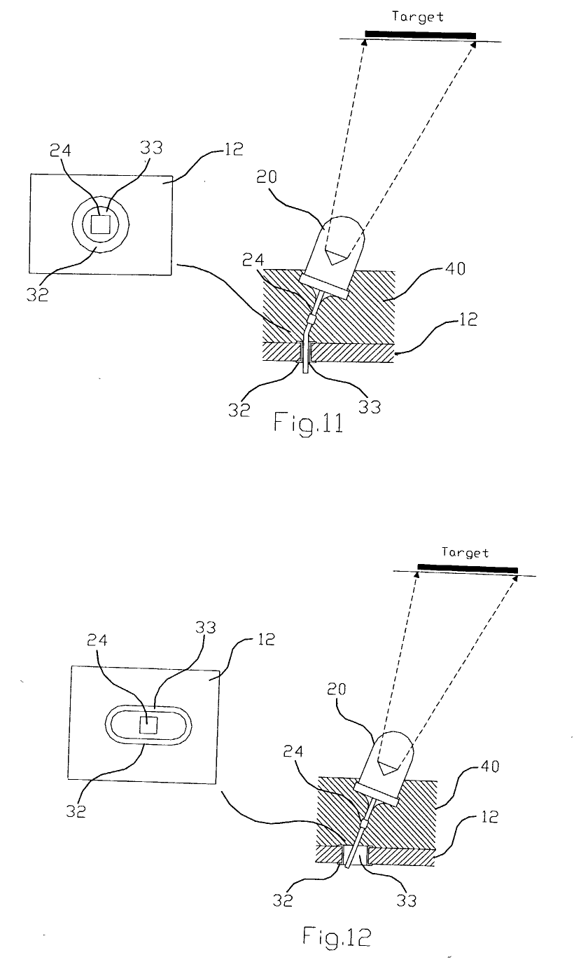

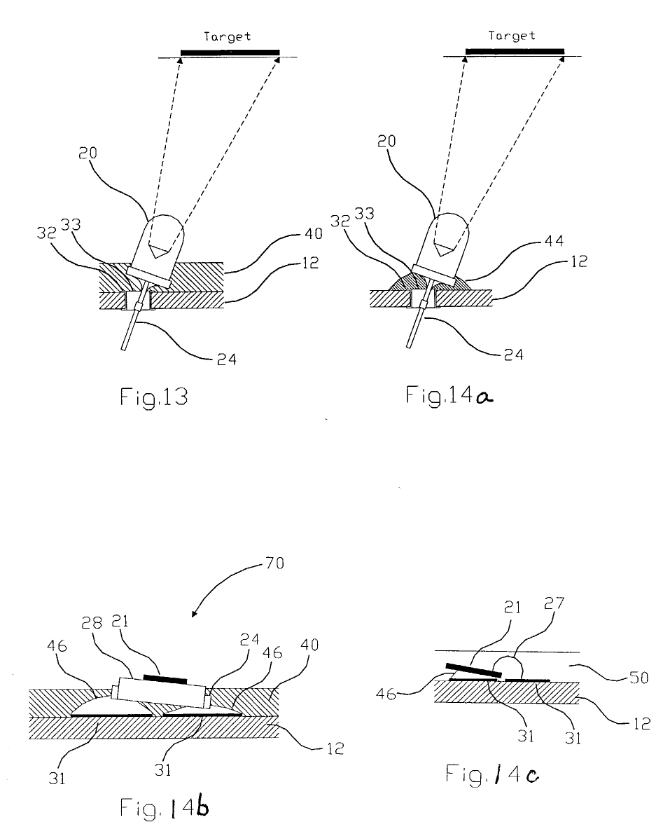

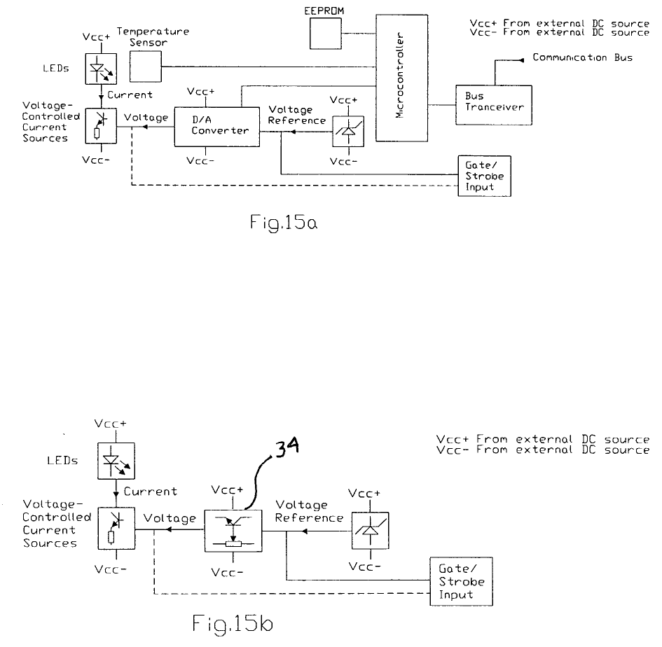

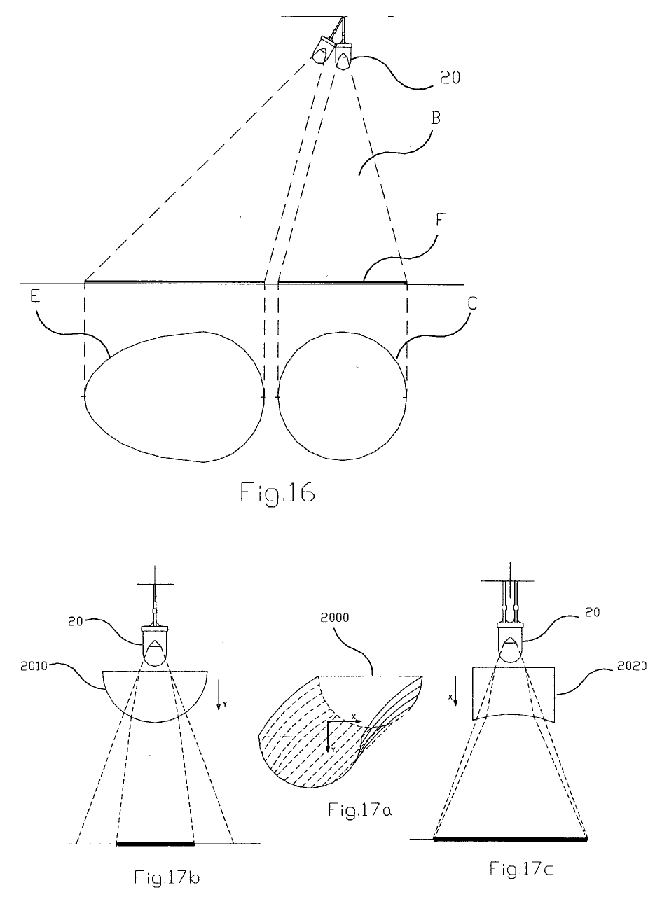

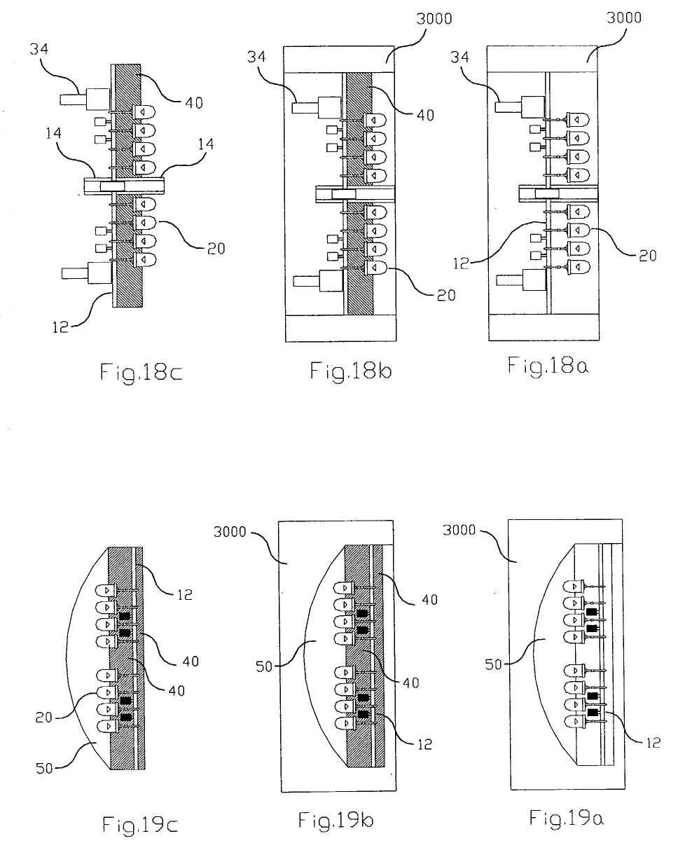

As shown in FIG. 8a, threaded rings 641 may be attached to the LED illuminator 610 or molded as part of the LED illuminator 110 as shown in FIG. 8b. Such LED illuminators are generally for use in microscopy and machine vision applications. LED illuminators including molded threads are easy to manufacture, and enable wide flexibility in providing a variety of optical functions. In the preferred embodiment, the threads 642 are standardized to accept commercially available mounted optical devices such as lenses, filters 643, or any combination thereof. These molded threads can also accept custom attachments and/or serve as a platform for affixing mounting hardware. For example, a ring-shaped LED illuminator with molded threads may be threadably attached to the front of a microscope or a camera in exactly the same way a lens is threadably attached to the front of a camera.

For workbench or table use, as shown in FIG. 9, an LED illuminator 210 as shown in FIGS. 4a and 4b in the shape of a rectangular frame with a translucent optical device such as a magnifying device 60 mounted therein is attached to a stand assembly 1000. The rectangularly shaped LED illuminator 210 is pivotably mounted 1030 so that it can be rotated so the angle of the magnifying device 60 and light may be adjusted. The stand 1000 shown is lightweight. The flat area on the bottom 1010 balances the weight of the illuminating module 210 and the magnifying device and provides stability.

Those of ordinary skill in the art will understand that according to the disclosed invention, LED illuminators may be formed in any shape suitable to provide light for a wide array of applications, including but not limited to photography, video, shop windows, or specialty product displays. For use in remote locations, the LED illuminators of the present invention may be equipped with rechargeable batteries either encased in an epoxy layer or attachable to the electronic componentry through a power connection. Because of the durability and rugged construction of the disclosed LED illuminator, it may be used in outdoor settings, marine applications, or hostile environments.

Method of Manufacture

General Considerations

The flexibility and adaptability of the LED illuminator of the present invention enables the creation of a wide variety of products. Because of the flexibility and adaptability of the present invention, the construction of an LED illuminator according to the present invention begins with an assessment of illumination requirements. Specifically, the illumination requirements in terms of light color, light pattern, and light intensity are determined. Second, the needed electrical capabilities concerning power, switching, and programmability for the illumination requirements are assessed. Third, the shape and light distribution requirements for either the cover or the outer epoxy layer are defined. With these basic requirements defined, the process of building the LED illuminator is initiated by selecting the LED assemblies to be used and determining the arrangement of the individual LED assemblies on a printed circuit board. Once the individual LED assemblies and the electronic componentry are mounted to the printed circuit board, the LED assemblies are individually aligned or attuned to obtain the needed light pattern. Once individually attuned, the individual LED assemblies are affixed with respect to the printed circuit board within an epoxy layer. These basic process steps will be explained in greater detail in the paragraphs will follow.

Selection of LED Assemblies

Individual LED assemblies come in a variety of colors, to include red, white, green and blue. Once the desired color or array of colors is selected, the pattern and light intensity is assessed. If multiple LED assemblies mounted close to one another can be used, then the intensity of light output from any individual LED assembly can be reduced. Once the array of LED assemblies needed and their mounting pattern has been determined, the needed power requirements as well as the operating temperatures must also be considered. Such considerations will determine the electrical componentry needed to support the array of LED assemblies selected.

For red LED assemblies, the luminosity is linearly proportional to the current throughout the whole useful range of currents. For white, green, and blue LED assemblies, this linear relationship between luminosity and electrical current holds for currents up to 20 milliamps. But for currents over 20 milliamps, the light output of the individual white, green, and blue LED assembly increases at a lower rate. The light output of any given individual LED assembly is also a function of temperature. In general, at any given level of current, the higher the temperature of the individual LED assembly, the lower the light output. For red LED assemblies, the light output at 80° Celsius is 30% lower than its light output at 20° Celsius. For white and green LED assemblies, the light output at 80° Celsius is 20% lower than at 20° Celsius. Blue LED assemblies show almost no change in light output at elevated temperatures.

When current flows through a chip in an individual LED assembly, both light and heat are generated. Increasing the current through the chip raises the light output but increased current flow also raises the temperature of the chip in the individual LED assembly. This temperature increase lowers the efficiency of the chip. Overheating is the main cause of the failure of individual LED assemblies. To assure safe operation, either the current, and as a result the light output, must be kept at a low level or some other means of transferring heat away from the chip in the individual LED assembly must be provided.

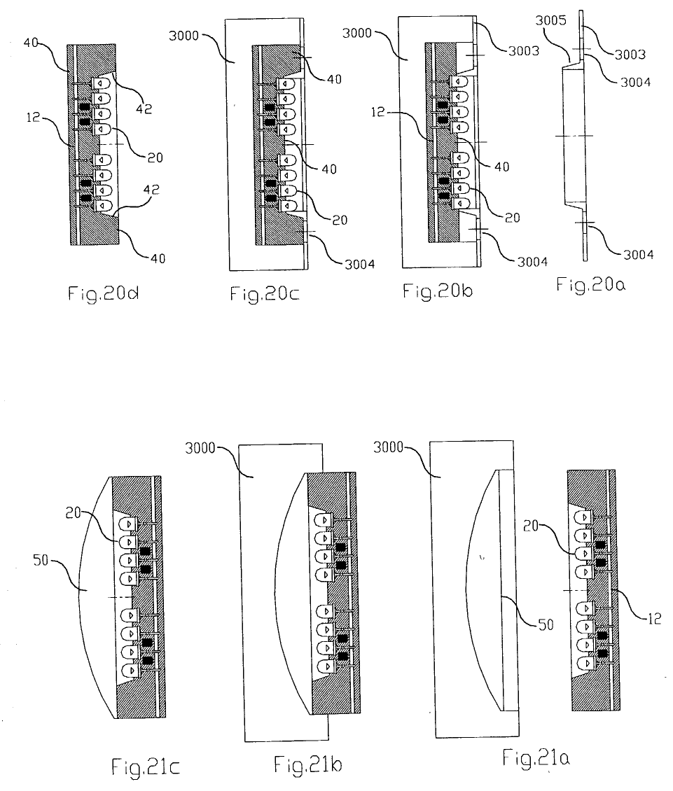

A still better understanding of the complexities associated with the use of LED assemblies may be had from an understanding of how an individual LED assembly is constructed. Specifically, inside an individual LED assembly 20, as shown in FIG. 10a, the LED chip 21 is mounted in a metal reflecting cup 23. The metal reflecting cup 23 is welded to a metal electrode 25. Because metal is a good heat conductor, the reflector cup 23 and the metal electrode 25 provide a heat transfer path away from the LED chip 21. The second metal electrode 26 also transfers heat away from the LED chip 21 because of its proximity to the reflector cup 23. A gold wire 27 passes from the second metal electrode 26 to the LED chip 21. Metal leads 24 extend from the individual LED assembly 20 to provide connection to the printed circuit board 12. The heat related problems and limitations are magnified when multiple individual LED assemblies are mounted in close proximity to one another.

Those of ordinary skill in the art will understand that either surface mount LEDs or LED chips may be used in place of the individual LED assembly shown in FIG. 10a. Shown in FIG. 10b is a surface mount LED assembly 70. The light generating semiconductor chip 21 is mounted on one of the two conductive pads 29, which pads are electrically connected to their respective metal leads 24. One end of the gold wire 27 is soldered to the other conductive pad 29. The other end of the gold wire 27 is welded to the top surface of the chip 21. The body 28 of the surface mount LED 70 is made of plastic or some other nonconductive material.

Electronic Componentry

Once the electrical requirements to provide current to the array of individual LED assemblies have been ascertained, the electronic componentry to provide the correct amount of current or electrical energy to the selected numbers and colors of LED assemblies is determined. To expand utility to a variety of applications, different switching and current flow control systems may be used.

Basic parts of the current flow control and switching systems are shown in FIG. 15a and FIG. 15b. The intensity of light generated by the LED assemblies depends on the volume of current flowing through the LED assemblies. Groups of LED assemblies are electrically connected to voltage-controlled current sources. Voltage-controlled current sources force the current to flow through the LED assemblies. The volume of the current depends on the level of the voltage supplied to the inputs of the current sources.

As previously indicated, in manually controlled systems, and as now shown in FIG. 15b, the level of the voltage supplied to the inputs of the current sources is controlled by one or more potentiometers 34. Rotational position of the potentiometer 34 determines what fraction of the reference voltage on its input is seen on its output. The user manually adjusts the rotational position of the potentiometer 34 to adjust the amount of current flowing through the LED assemblies and therefore the intensity of light generated by the LED assemblies.

In computer-controlled systems, as shown in FIG. 15a, a Digital-to-Analog (D/A) converter controls the level of the voltage supplied to the inputs of the current sources. A digital code currently in memory or in a register of the D/A converter determines what fraction of the reference voltage on its input is seen on its output. The digital code, and therefore the intensity of light, may be set or modified by an external computer.

To set the intensity of light generated by the LED assemblies to a specific level, the external computer determines the digital code corresponding to the desired light intensity and sends this digital code to the D/A converter through a communication bus in the form of a “set” command. To adjust the light intensity up or down, the computer determines the step of the adjustment and sends it in the form of an “up” or “down” command.

The type of communication bus implemented depends on the communication means implemented on the external computer. The transceiver translates the electrical format used on a particular communication bus to the format acceptable by the microcontroller.

A microcontroller decodes the command received from the external computer to determine the requested action and sends a specific code to the D/A converter.

An on/off switch may be implemented in both the manually and computer-controlled current flow control and switching systems. The on/off switch may also be achieved by setting the volume of current flowing through the LED assemblies to zero, by turning the potentiometer all the way down, in manually controlled systems (FIG. 15b), or setting the D/A code to zero in computer-controlled systems (FIG. 15a).

A Gate/Strobe input may also be implemented. When active, the Gate/Strobe input forces to zero the voltage supplied to the input of current sources, overriding the action of the potentiometers or D/A converter. As shown in both FIG. 15a and in FIG. 15b, the Gate/Strobe input may force to zero the voltage supplied to the input of current sources directly, or indirectly by forcing the reference voltage to zero.

The Gate/Strobe input, when connected to an external switch, provides a gating action. Any time the switch is on, the light goes off. Any time the switch if off, the light is on with the light intensity as set by the rotational position of the potentiometers or by the code in the D/A converter.

The same input, when connected to an external generator, provides strobe or pulse action. The light is turned on and off as before, with the on and off times forced by the generator.

A strobe or pulse action may also be implemented internally in the firmware of the microcontroller.

An EEPROM memory, when implemented in a computer-controlled system, remembers the last code used by the D/A converter before the power was turned off. On power up, the microcontroller reads the code from the EEPROM and sends it to the D/A converter so the illuminator resumes its operation as it was before the power was turned off. Some commercially available A/D converters and microcontrollers come with EEPROM on board. The EEPROM shown in FIG. 15a indicates the presence of EEPROM in the system, either as a stand alone IC or part of other components. Also, any other type of non-volatile memory, that is a memory able to preserve its contents without the externally supplied power, may be used.

A temperature sensor, when implemented in a computer-controlled system shown in FIG. 15a, tracks the temperature of the body of the illuminator. The microcontroller periodically reads the temperature sensor to determine the current temperature inside the body of the illuminator. With the known dependency of intensity of light generated by LED assemblies on the temperature of the LED assemblies, the microcontroller determines the necessary adjustments of the volume of current flowing through the LED assemblies needed to keep the light intensity at a constant level.

Accordingly, in the LED illuminator of the present invention, there is no need for an external controller. All of the electronics needed to control the individual LED assemblies can be mounted on the printed circuit board, or, if desired, completely encased in epoxy.

If remote control is not required, the intensity of the light emitted by specific segments of the LED illuminator may be adjusted manually by potentiometers which include adjustment knobs accessible on either the top, side, bottom, or back of the LED illuminator.

Assembly and Molding

Once the desired array of individual LED assemblies 20 has been established and the required electronic componentry to control the operation of the individual LED assemblies 20 is selected, the LED illuminator is put together. The construction process begins with a fully assembled printed circuit board 12 including hardware such as standoffs 14 secured thereto and desired electronic componentry soldered on one side of the printed circuit board, constructed with through-hole pairs for individual LED assemblies 20.

As shown in FIG. 11, a substantially circular through-hole 33 on the printed circuit board 12, intended for an individual LED assembly 20, is oversized to allow the insertion of the metal lead 24 of the individual LED assembly 20. The metal leads 24 of an individual LED assembly 20 are inserted into the pair of through-holes provided for the individual LED assembly 20 so the body of the individual LED assembly 20 is positioned at the predetermined distance from the surface of the printed circuit board 12. The leads 24 are soldered to the printed circuit board 12

The fully assembled printed circuit board 12, with individual LED assemblies soldered to the printed circuit board 12, is placed in an attunement fixture with the individual LED assemblies facing an illumination target. An individual LED assembly 20 is energized by connecting its leads to a current source. By bending the metal leads 24 of the currently energized individual LED assembly 20, the light beam emitted by the LED assembly is directed to a predetermined area on the illumination target. The metal leads 24 are both flexible enough to make this operation very easy and rigid enough to keep the individual LED assembly 20 in the desired position for the duration of the attunement and molding process. The process is repeated for all individual LED assemblies 20 soldered to the printed circuit board 12. The printed circuit board 12 with all individual LED assemblies 20 attuned may be retested and the accuracy of the attunement of each individual LED assembly may be evaluated. When necessary, each single individual LED assembly 20 may be attuned additional times, as needed, to obtain the best illumination pattern.

As shown in FIGS. 12, 13 and 14, the through-hole 33 on the printed circuit board 12 intended for an individual LED assembly 20 is oversized in an axis parallel to the illumination target, and shaped as a slot oriented in the direction of an alignment target. This slot shaping technique allows the metal leads 24 of each individual LED assembly 20 to be positioned inside the through hole 33 at any angle along the length of the elongated through hole 33 while still leaving some room on both sides of the elongated through hole 33. In some applications it is advantageous to maintain the body of each individual LED assembly 20 in close proximity to the surface of the printed circuit board 12, as shown in FIGS. 13 and 14.

If a surface mounted LED is used, the attunement process is illustrated in FIG. 14a. Specifically, a drop of conductive, initially flowable and subsequently hardenable medium 46 is deposited on each of the two conductive pads 31. The surface mount LED 70 is placed on the pads 31 so that its two leads 24 are in contact with the medium 46. A current source is electrically connected to the pads 31 so that the surface mount LED 70 starts emitting light. The surface mount LED 70 is then positioned so that its light beam illuminates a desired area, and is then held in that position until the medium 46 hardens.

If an LED chip is used, the attunement process is illustrated in FIG. 14b. Specifically, a drop of conductive, initially flowable and subsequently hardenable medium 46 is deposited on the conductive pad 31 intended for the chip 21. The LED chip 21 with a gold wire 27 welded to its top surface is then placed on the pad 31 so that its bottom surface is in contact with the medium 46. The unconnected end of the gold wire 27 is soldered to the other pad 31. A current source is electrically connected to the pads 31 so the LED chip 21 starts emitting light. The LED 21 is positioned so its light beam illuminates a desired area, and is then held in that position until the medium 45 hardens.

The fully assembled printed circuit board 12, but with no individual LED assemblies soldered thereto, is placed in an attunement fixture with the side on which the individual LED assemblies 20 are going to be mounted facing an illumination target.

An individual LED assembly 20 is energized by connecting its leads to a current source. The metal leads 24 of the currently energized individual LED assembly 20 are inserted in the pair of elongated through-holes 33, on the printed circuit board 12, provided for this individual LED assembly 20. The body of the currently energized individual LED assembly 20 is held at a desired distance from the surface of the printed circuit board 12. By tilting the currently energized individual LED assembly 20, as shown in FIGS. 12, 13 and 14, its light beam is directed to a predetermined area on the illumination target. While holding the individual LED assembly steady, the metal leads of the individual LED assembly are soldered to the solder pads 32 surrounding the through-holes 33. The process of inserting, attunement and soldering is repeated for all individual LED assemblies 20. The printed circuit board 12, with all individual LED assemblies 20 attuned, may be retested, and the accuracy of the attunement evaluated. If necessary, each individual LED assembly 20 may be attuned additional times by bending its leads 24, or the solder may be removed so the process of attunement and soldering may be repeated.

Individual alignment of the LED assemblies 20 is required because no two individual LED assemblies are exactly the same. As may be seen in FIG. 10a, differences arise from the positioning of the chip 21 inside the reflector cup 23 as shown, the positioning of the reflector cup 23, the positioning of the electrodes 25 and 26, and the positioning of the cathode 25. All of these factors affect the geometry and direction of the beam of light. Due to the manufacturing process of individual LED assemblies 20, the components in individual LED assemblies 20 exhibit a very wide range of positional relationships. Therefore, for any application that requires illumination of a specific area, each individual LED assembly 20 must be manually aligned and then permanently held in place by some means of mechanical support.

Individual LED assemblies 20 are available as either narrow or wide half-power angle. The difference between the narrow or wide half-power angle is substantial. In many cases, for a given size of an area to be illuminated and a desired working distance, one LED assembly may emit a light pattern too narrow to fully illuminate an object at a larger distance. The other LED assembly may emit a light pattern too wide, thereby illuminating an area much bigger than needed. To change the size of the illuminated area, a lens in the shape of a slice of donut may be either attached or molded on the front of the LED illuminator to converge the light beam. For a given value of a diffraction index, the converging action of the lens depends on the radius of the lens and the positioning of the individual LED assembly with respect to both surfaces of the lens. Both the radius and position of the individual LED assembly may be established during the design process to optimize the illumination of the object.

As shown in FIG. 16, a beam of light from an individual LED assembly typically forms a cone B. This conical beam of light B, when projected on a flat surface F perpendicular to the axis of the cone B, forms a circle C. When the beam of light B is projected onto a flat surface F at an angle to the cone B, it forms a distorted ellipse E. Typically, a ring-light in a machine vision application has its individual LED assemblies positioned at an angle to the illumination target. As a result, either some areas of the illuminated area are darker than the center, or the illuminated area is bigger than the target.

To better illuminate the target, as shown in FIG. 17a, a lens in the shape of a slice of donut 2000 may be either attached or molded on the front of a ring-light. The lens may be considered as a superposition of two independent lens shapes as shown in FIGS. 17b and 17c. The first independent lens is a plano convex converging lens 2010. The second independent lens is a plano concave diverging lens 2020. The radius of the lens may be selected to shape the conical beam of light emitted from the LED assemblies to provide the optical illumination pattern.

Selection of the epoxy to be used is an essential part of the construction process. Key characteristics are clarity and the ability of the epoxy to transfer or conduct heat.

As previously indicated, additives in the form of small particles or dyes may be mixed with the clear epoxy to add special effects such as diffusing, fluorescence, color, or filtering. The intensity of each one of these effects is controlled by volume of the additive mixed with the clear epoxy.

It is well known that there are commercially available clear optical epoxies with different light diffusing properties. The transmission and diffusing properties of the epoxy depends on the type of epoxy and the thickness of the layer.

Following the construction of a printed circuit board, the alignment of the individual LED assemblies, the selection of the epoxy, and the determination of the external shape of the epoxy layer, the LED illuminator may be put together for use.

As shown in FIGS. 18a, 18b, and 18c, the printed circuit board 12 with the aligned individual LED assemblies 20 and supporting electronic componentry attached thereto is placed inside a mold 3000. The inner surfaces of the mold 3000 are treated with a mold release agent. If needed, unsealed components are sealed with a non-hardening sealer. As shown in FIG. 18b, epoxy 40 is poured into the mold 3000 and allowed to cure. Once cured, the circuit board 12 with a cured epoxy layer 40 formed thereon is removed from the mold 3000 as shown in FIG. 18c. Depending on the type of LED illuminator required, there may be several variations in the way the epoxy 40 is applied and the kinds of epoxy used.

In the simplest embodiment, the printed circuit board is placed in the mold 3000 with the LED assembly side of the printed circuit board 12 facing up. No flow-through openings are formed in the printed circuit board. Epoxy 40 is poured on the printed circuit board 12 so the leads 24 and the bottom part of each individual LED assembly 20 are submerged in the epoxy 40 up to the level at which the dome portion 22 of each individual LED assembly 20 is located. After curing, the printed circuit board 12 with the layer of epoxy 40 formed thereon is removed from the mold 3000 and may then be inserted in a traditional housing. As previously indicated, a thin light diffuser may be placed on and mechanically attached to the face of the housing.

When a layer of epoxy 40 is required on the other side of the printed circuit board 12, after the layer of epoxy 40 is cured, the mold 3000 with the module inside is flipped over and epoxy 40 is poured to a desired level. Or a mold 3000, as shown in FIG. 20b, but without the insert, may be used to deposit a layer of epoxy 40 on both sides of the printed circuit board 12, with the epoxy 40 entering the bottom side of the printed circuit board, through one or more flow-through holes formed in the printed circuit board 12.

As shown in FIG. 19a, in another method of manufacture, a clear epoxy 50 is poured into the mold 3000 first. The printed circuit board 12 is then inserted into the mold 3000 with LED assembly side of the printed circuit board 12 facing down so the dome portion of the individual LED assemblies are submerged in the clear epoxy layer 50. As shown in FIG. 19b, after the clear epoxy 50 is cured, a layer of epoxy 40 is then poured into the mold through flow-through holes formed in the printed circuit board 12. The epoxy 40 is poured to come up to the surface of the printed circuit board 12 only or, as shown in FIG. 19b, may be poured to over the other side of the printed circuit board 12 up to a desired level. As shown in FIG. 19c, after curing, the printed circuit board 12 with two layers of epoxy 40 and 50 is removed from the mold 3000.

In yet another method of manufacture, the printed circuit board 12 is inserted into the mold 3000 first, with LED assembly side of the printed circuit board 12 facing down, and then the layer of clear epoxy layer 50 is poured into the mold through flow-through holes formed in the printed circuit board 12, up to the level when dome portion of the individual LED assemblies are submerged in the clear epoxy layer 50, as shown in FIG. 19a. The rest of the steps are as previously disclosed.

In still yet another method of manufacture, the layer of clear epoxy 50 is poured up to the surface of the printed circuit board 12, forming a one-layer module.

As shown in FIG. 20b, in yet another method of manufacture, an insert 3003, as shown in FIG. 20a, is utilized to mold a layer of epoxy 40 to form a wall 42 surrounding the individual LED assemblies. The insert 3003 has an opening in the center, walls 3005 surrounding the opening, and flow-through holes 3004 formed around the walls 3005. The printed circuit board 12 is placed in the mold 3000, with the LED assembly side of the printed circuit board 12 facing up. Epoxy 40 is poured on the printed circuit board 12 so the leads 24 and the bottom part of the body of each individual LED assembly 20 is submerged in the epoxy 40. When flow-through holes exist in the printed circuit board 12, the layer of epoxy 40 extends to the other side of the printed circuit board 12. The insert 3003 is treated with a mold-release agent, and placed on the mold 3000, as shown in FIG. 20b, so the bottom part of the walls 3005 of the insert 3003 are partially submerged in the epoxy layer 40. After the-layer of epoxy 40 is cured, the second layer of epoxy 40 is poured through the flow-through holes around the walls 3005 of the insert 3003, as shown in FIG. 20c, filling the space between the walls 3005 and inner walls of the mold 3000 but not entering the spaces inside the walls 3005. After the second layer of epoxy 40 is cured, the insert 3003 is removed from the mold 3000 first and the printed circuit board 12 with two layers of epoxy 40, where the top layer of epoxy 40 forms a wall 42 surrounding the LED assemblies 20, is removed from the mold 3000.

In general, the disclosed method of manufacture is used to form molded walls 42 around the LED assemblies. In particular, the disclosed method may be used to form threaded walls 641 as shown in FIG. 8b. To form threads on either side of the molded wall 641, the wall 3005 of the insert 3003 is threaded. To form threads on both sides of a molded wall 641, two inserts 3003 are used with their respective walls 3005 threaded.

As a continuation of the method of manufacture shown in FIGS. 20a, 20b, 20c and 20d, a layer of clear epoxy 50 may be molded in front of the LED assemblies, as shown in FIGS. 21a, 21b and 21c. A clear epoxy 50 is poured into the mold 3000 first. The module, as shown in FIG. 20d, with two layers of epoxy 40 deposited on the printed circuit board 12, where one of the layers is forming walls surrounding the LED assemblies, is then inserted into the mold 3000 with LED assembly side of the printed circuit board 12 facing down, so the bottom portion of the wall surrounding the LED assemblies makes contact with the clear epoxy layer 50 but neither part of the LED assembly is in contact with the clear epoxy layer 50.

When a layer of clear epoxy 50 is molded at the front of an illuminator, the outer surface of the layer 50 may be molded into a “wavy” pattern or sanded to have a roughened surface after the curing process to provide diffusing of the light emitted from the LED assemblies.

A layer of a clear epoxy, with or without additives, may be molded on the front of an illumination module to almost any shape, cross-section, and thickness. This layer of clear epoxy serves as a transparent cover to modify or enhance the optical properties of the individual LED assemblies. Molding this layer of clear epoxy in the shape of a lens may increase the converging or the diverging of light from the individual LED assemblies. When the lens portion of the individual LED assemblies are not submerged in this layer of clear epoxy, the optical action of the outer surface of the molded layer modifies the action of the lens portion of the individual LED assemblies. Submerging the lens portion of the individual LED assemblies in this layer of clear epoxy substitutes the converging action of the lens portion of the individual LED assemblies with a desired optical action determined by the outer surface of the molded layer of clear epoxy.

In all disclosed methods of manufacture, when an electronic component or part of a mounting hardware protrudes beyond the contours of the printed circuit board 12, as shown in FIGS. 3a, 3b, 6a, 6b, 7a, 7b and 8b, a two-piece mold 3001 and 3002, as shown in FIGS. 22a and 22b, is used.

Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

What is claimed is:

1. An self-contained illuminator comprising:
at least one light emitting diode assembly;
electrical componentry to cause said at least one light emitting diode assembly to emit a predetermined amount of light;
at least one PC board for enabling attuning the physical position of said at least one light emitting diode assembly and for mounting said electrical componentry;
a self-hardening flowable medium in contact with said at least one PC board to affix said at least one light emitting diode assembly in said attuned position.

2. The self-contained illuminator as defined in claim 1 further including at least one additional layer of a translucent self-hardening flowable medium.

3. The self-contained illuminator as defined in claim 1 wherein said electrical componentry is encased in a self-hardening flowable medium.

4. The self-contained illuminator as defined in claim 1 wherein said self-hardening flowable medium is molded to enable attachment to another device.

5. The self-contained illuminator as defined in claim 1 wherein said self-hardening flowable medium is molded to enable attachment of another device to the self-contained illuminator.

6. The self-contained illuminator as defined in claim 1 wherein said electrical componentry further includes a microcontroller.

7. The self-contained illuminator as defined in claim 1 wherein said enabling attuning the physical position of said at least one diode assembly includes a soldered connection between electrical leads from said at least one light emitting diode assembly and said at least one PC board and then bending the leads of said at least one light emitting diode assembly.

8. The self-contained illuminator as defined in claim 1 wherein said at least one light emitting diode assembly is a surface mount light emitting diode assembly.

9. The self-contained illuminator as defined in claim 8 wherein said enabling attuning the physical position of said at least one surface mount light emitting diode assembly includes mounting said at least one surface mount light emitting diode assembly to said at least one PC board in a predetermined position using said self-hardening flowable medium and holding said at least one surface mount light emitting diode assembly in said predetermined position while said self-hardening flowable medium hardens.

10. The self-contained illuminator as defined in claim 1 wherein said at least one light emitting diode assembly is a chip.

11. The self-contained illuminator as defined in claim 10 wherein said enabling attuning the physical position of said at least one chip includes mounting said at least one chip to said at least one PC board in a predetermined position using said self-hardening flowable medium and holding said at least one chip in said predetermined position while said self-hardening flowable medium hardens.

12. The self-contained illuminator as defined in claim 6 wherein said microcontroller adjusts the electrical current flowing to said at least one light emitting diode assembly based on the temperature of said light emitting diode assembly.
